(19) United States
(12) Patent Application Publication
(10) Pub. No.: US 2026/0299505 A1
(43) Pub. Date: Oct. 1, 2026

(54) FIXING DEVICE AND IMAGE FORMING APPARATUS PROVIDED WITH FIXING DEVICE

(71) Applicant: CANON KABUSHIKI KAISHA, Tokyo (JP)

(72) Inventor: AKITOMO MIYAMOTO, Chiba (JP)

(21) Appl. No.: 19/562,599

(22) Filed: Mar. 10, 2026

(30) Foreign Application Priority Data
Mar. 28, 2025 (JP) 2025-054676

(51) Int. Cl. G03G 15/00; G03G 15/20

(52) U.S. Cl. CPC G03G 15/80; G03G 15/2039; G03G 2215/00978

(57) ABSTRACT

A fixing device that fixes a toner image formed on a recording medium includes a fixing heater, at least one fixing sensor configured to acquire information about the fixing device, a drawer connector, and a relay board configured to relay a connection between the fixing sensor and the drawer connector, wherein the relay board includes a first terminal and a second terminal that are connected to the fixing sensor, a third terminal and a fourth terminal that are connected to the drawer connector, and a wiring pattern that electrically connects the first terminal, the second terminal, the third terminal, and the fourth terminal to one another.

### BACKGROUND

### Field of the Technology

The present disclosure relates to a fixing device and an image forming apparatus provided with the fixing device.

### Description of the Related Art

In recent years, fixing devices of image forming apparatuses have been provided with a plurality of sensors, such as temperature sensors and photo sensors, in order to achieve optimal temperature control. On the other hand, the fixing devices are generally assumed to be replaced as consumables. Therefore, the fixing device is connected to a main body of the image forming apparatus via a detachable drawer connector.

Japanese Patent Laid-Open No. 2025-007103 discusses a fixing device provided with a relay board as a means for reducing the number of pins of a drawer connector. Specifically, the fixing device discussed in Japanese Patent Laid-Open No. 2025-007103 is provided with a plurality of thermistors. A pull-up voltage to the plurality of thermistors is supplied from a main body to a common terminal of the drawer connector via a common electric wire. The wire supplying the pull-up voltage branches off in the relay board of the fixing device, and the pull-up voltage is distributed to each of the plurality of thermistors. This configuration reduces the number of pins of the drawer connector.

### SUMMARY

An aspect of the present disclosure provides a fixing device that fixes a toner image formed on a recording medium, with the fixing devices including a fixing heater, at least one sensor configured to acquire information about the fixing device, a drawer connector, and a relay board configured to relay a connection between the at least one sensor and the drawer connector. The relay board includes a first terminal and a second terminal that are connected to the at least one sensor, a third terminal and a fourth terminal that are connected to the drawer connector, and a wiring pattern that electrically connects the first terminal, the second terminal, the third terminal, and the fourth terminal to one another.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic cross-sectional view of an image forming apparatus according to an embodiment.

FIG. 2 is a schematic cross-sectional view of a fixing device according to the embodiment.

FIG. 3 is a circuit diagram of the fixing device and a periphery thereof, according to the embodiment.

FIG. 4 is a schematic diagram illustrating a relay board according to the embodiment.

### DESCRIPTION OF THE EMBODIMENTS

Embodiments of techniques according to the present disclosure will be described below with reference to the attached drawings. Unless otherwise specified, sizes, materials, relative positions, and other aspects of each component of an image forming apparatus described below are not intended to limit the scope of the present disclosure. Further, members and portions that are common to the drawings are denoted by the same reference numerals. Duplicate descriptions are avoided for clarity, as appropriate.

In a fixing device provided with a relay board, in a case where a disconnection occurs anywhere along a path from a power supply that supplies a pull-up voltage to wiring on the relay board, there is a possibility that functions of each thermistor of a plurality of thermistors may cease. Thus, there remains room for improvement in the reliability of sensors. According to some embodiments of the technique in the present disclosure, it is possible to improve the reliability of sensors in a fixing device.

### First Embodiment

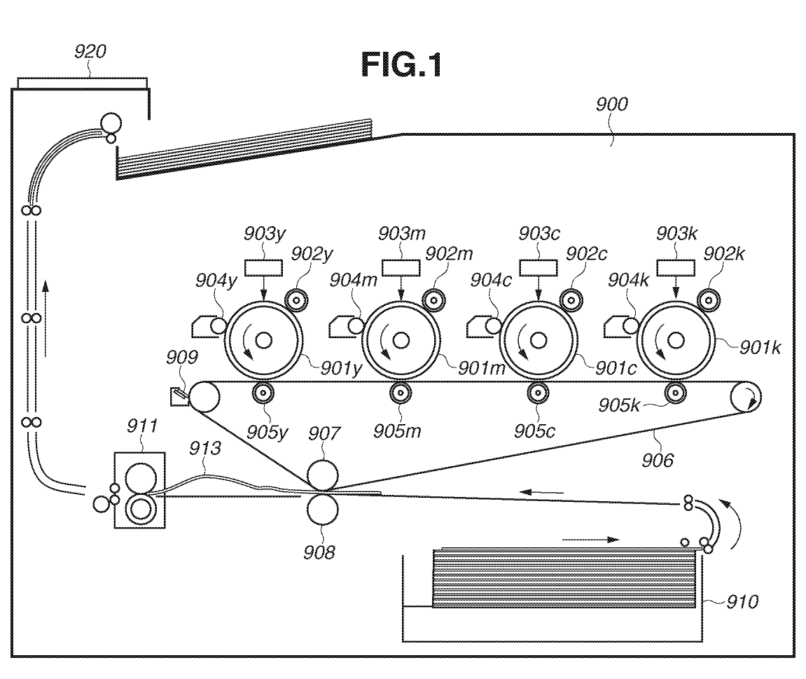

FIG. 1 is a schematic configuration diagram illustrating an image forming apparatus according to a first embodiment of the present disclosure. The image forming apparatus is a printer that forms a toner image on a recording medium based on image information input from an external host apparatus, such as a personal computer to a control circuit unit. The image forming apparatus according to the present embodiment adopts an electrophotographic process. The image forming apparatus is provided with four color image forming units that are tandem and intermediate transfer type. The four image forming units respectively form toner images of yellow (Y), magenta (M), cyan (C), and black (K) colors, from left to right. These four image forming units have similar configuration and, in the following description, are described with a suffix (y, m, c, or k) representing the respective color. Unless otherwise specified, a description of the image forming unit of one color also applies to the image forming units for the other colors.

In FIG. 1, a printer main body 900 includes a photosensitive drum 901y. The photosensitive drum 901y rotates counterclockwise around an axis perpendicular to a paper plane. A primary charging roller 902y uniformly charges a surface of the photosensitive drum 901y. A laser unit 903y irradiates the uniformly charged surface of the photosensitive drum 901y with laser. The surface of the photosensitive drum 901y is exposed by the laser irradiation, and a latent image is formed on the surface of the photosensitive drum 901y. Next, the surface of the photosensitive drum 901y passes through a developing sleeve 904y where the latent image on the photosensitive drum 901y is developed with toner of corresponding color (yellow for the photosensitive drum 901y). Subsequently, the surface of the photosensitive drum 901y comes into contact with an intermediate transfer belt 906. A voltage is applied to a primary transfer roller 905y, and thus the yellow toner on the surface of the photosensitive drum 901y is transferred onto a surface of the intermediate transfer belt 906.

Similarly, magenta, cyan, and black toners are transferred onto the surface of the intermediate transfer belt 906 via photosensitive drums 901m, 901c, and 901k, primary charging rollers 902m, 902c, and 902k, laser units 903m, 903c, and 903k, developing sleeves 904m, 904c, and 904k, and primary transfer rollers 905m, 905c, and 905k. In this way, images formed with the yellow, magenta, cyan, and black toners are formed on the intermediate transfer belt 906.

The toner image formed on the intermediate transfer belt 906 passes between a secondary transfer inner roller 907 and a secondary transfer outer roller 908. At the same time, a sheet 913 (recording medium) fed from a sheet cassette 910 is conveyed between the intermediate transfer belt 906 and the secondary transfer outer roller 908. Thus, the toner image formed on the intermediate transfer belt 906 is transferred onto a surface of the sheet 913. The sheet 913 passing through the secondary transfer inner roller 907 and the secondary transfer outer roller908 is conveyed to a fixing device 911. The toner image on the sheet 913 is heated in the fixing device 911. If the toner is softened by the heat, pressure is applied thereto so that the toner adheres to the surface of the sheet 913 and is fixed. The sheet 913 on which the image is formed in this way is discharged from the printer main body 900.

A series of image forming operations, as described above, is controlled by a heater control unit 406 based on each signal input from an operation unit 920, which may be provided on an upper surface of the printer main body 900, or via a network.

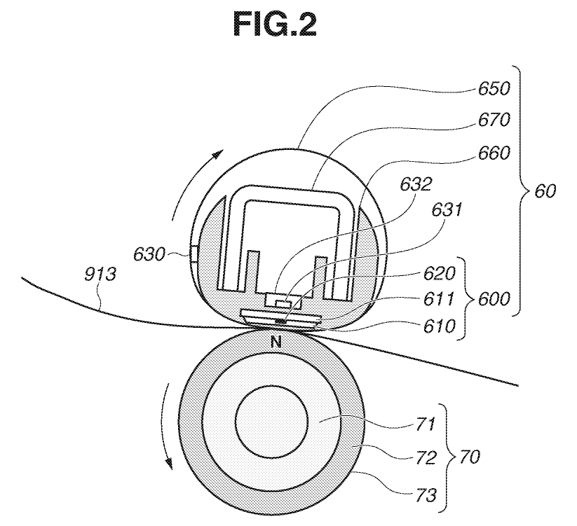

FIG. 2 is a schematic cross-sectional view of the fixing device 911 taken along a conveyance direction of the sheet 913. In FIG. 2, a fixing heater unit 60 includes a fixing heater 600 as a heating body, a heater holder 660, and a cylindrical fixing film 650. The heater holder 660 is a support body that supports the fixing heater 600. A U-shaped reinforced sheet metal 670 having an opening facing the fixing heater 600 is provided so that the fixing heater unit 60 is not deformed if pressed by a pressure roller 70.

The fixing heater 600 includes a substrate 610 having insulating properties, heat resistance, and low heat capacity, with its longitudinal direction perpendicular to the conveyance direction of the sheet 913, a heating element 620 on one surface of the substrate 610, and a protective glass 611 on a front surface of the substrate 610 for insulation. The fixing heater 600 is fixedly supported by the heater holder 660. A polyimide layer having a thickness of about 10 μm may be provided as a sliding layer on a surface of the substrate 610 that comes into contact with the fixing film 650. The polyimide layer reduces frictional resistance between the fixing film 650 and the fixing heater 600 (the substrate 610), thereby reducing driving torque and preventing wear on an inner surface of the fixing film 650.

The fixing film 650 includes a base material, an elastic layer formed on the base material, and an outermost surface layer formed thereon. A cylindrical base material is formed by processing stainless steel having a thickness of 30 μm into a cylindrical shape. The elastic layer is a silicone rubber layer having a thickness of about 300 μm. The silicone rubber layer is formed on the base material using a ring coating method. The silicone rubber layer is coated with a tetrafluoroethylene-perfluoroalkyl vinyl ether copolymer (PFA) resin tube having a thickness of 20 μm as the outermost surface layer. Grease is applied to the inner surface of the fixing film 650 to further improve a sliding property between the heater holder 660 and the inner surface of the fixing film 650. The fixing film 650 may be made of a cylindrical base material, such as a nickel-based metal material or a heat-resistant resin such as polyimide in addition to stainless steel. In a case where a heat-resistant resin such as polyimide is used as the base material, the polyimide layer as a sliding layer, which is described above, is not necessary.

The pressure roller 70 serving as a pressure member is disposed below the fixing heater unit 60. The pressure roller 70 has a multi-layer structure in which a silicone rubber layer 72 having a thickness of about 3 mm and a PFA resin tube 73 having a thickness of about 40 μm are laminated on a stainless-steel core metal 71, in this order. Both end portions of the core metal 71 of the pressure roller 70 are rotatably held by bearing between side plates of an apparatus frame.

The heater holder 660 is formed of a liquid crystalline polymer resin that has high heat resistance. The heater holder 660 holds the fixing heater 600 and serves as a guide for the fixing film 650 as well.

Both end portions of the heater holder 660 are urged in an axial direction of the pressure roller 70 by a pressing mechanism with a total pressure of 90 to 320 N. Thus, a lower surface of the fixing heater 600 (a surface opposite to a heating surface) is in pressure contact with an elastic layer of the pressure roller 70 with a predetermined pressing force, via the fixing film 650. In this way, a fixing nip portion N having a predetermined width is formed.

In the above-described configuration, the pressure roller 70 is driven to rotate by a drive system along the conveyance direction of the sheet 913, i.e., in a counterclockwise direction in FIG. 2. Accordingly, the cylindrical fixing film 650 rotates clockwise around the heater holder 660 while sliding in close contact with the substrate surface of the fixing heater 600.

A heater thermistor 631 and a film thermistor 630 are thermistors serving as temperature detection units, respectively. The heater thermistor 631 detects a temperature of the fixing heater 600. While the lower surface of the fixing heater 600, which serves as a heat source, is the heating surface, the heater thermistor 631 is disposed on an upper surface of the fixing heater 600, which is a non-heating surface. The film thermistor 630 is disposed on an inner or outer surface of the fixing film 650 and detects a temperature of the fixing film 650.

A thermostat 632 is a switch. If the thermostat 632 reaches a predetermined temperature, a bimetal of the thermostat 632 is reversed and a contact is opened. In this way, the thermostat 632 cuts off the power supply to the fixing heater 600 if the temperature of the fixing heater 600 exceeds the predetermined temperature.

If the pressure roller 70 is rotated and, accordingly, the cylindrical fixing film 650 is brought into a driven rotation state, the fixing heater 600 is energized. Then, in a state where the temperature of the fixing heater 600 is adjusted to a target value, the sheet 913 bearing the unfixed toner image is guided to the fixing nip portion N along an entrance guide. In the fixing nip portion N, a toner image bearing surface of the sheet 913 is brought into close contact with the outer surface of the fixing film 650, and the sheet 913 moves together with the fixing film 650. In the process in which the sheet 913 passes through the fixing nip portion N, heat from the fixing heater 600 is applied to the sheet 913 via the fixing film 650. The heat melts and fixes the unfixed toner images onto the sheet 913. After passing through the fixing nip portion N, the sheet 913 is separated from the fixing film 650 and discharged.

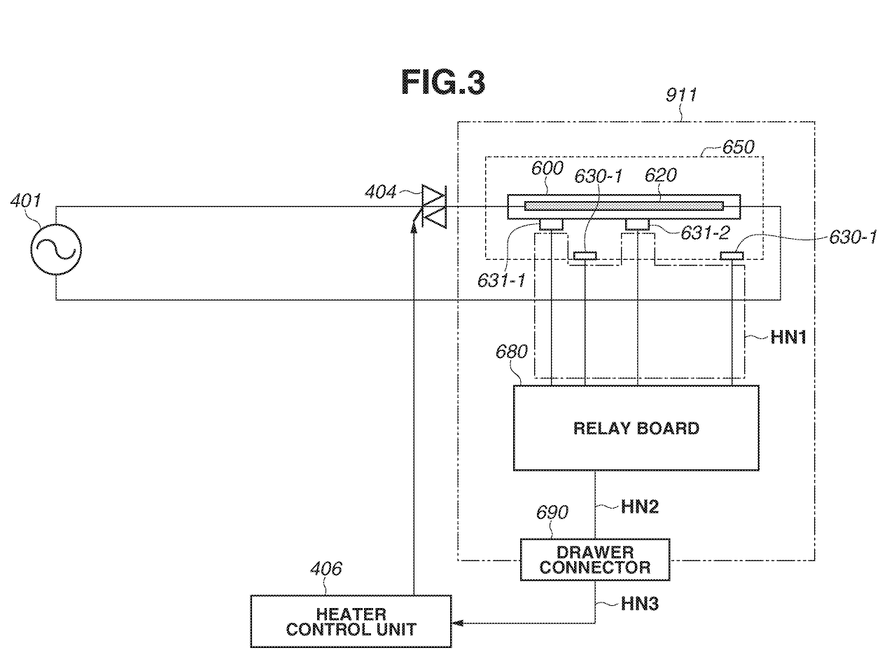

FIG. 3 is a circuit diagram of the fixing device 911 and a periphery of the fixing device 911 according to the present embodiment.

The fixing device 911 according to the present embodiment is detachably attached to the printer main body 900 as an integrated fixing device unit. The fixing device 911 serving as a fixing device unit specifically includes the fixing heater unit 60, the pressure roller 70, a fixing sensor, a relay board 680, and the drawer connector 690, which are described below.

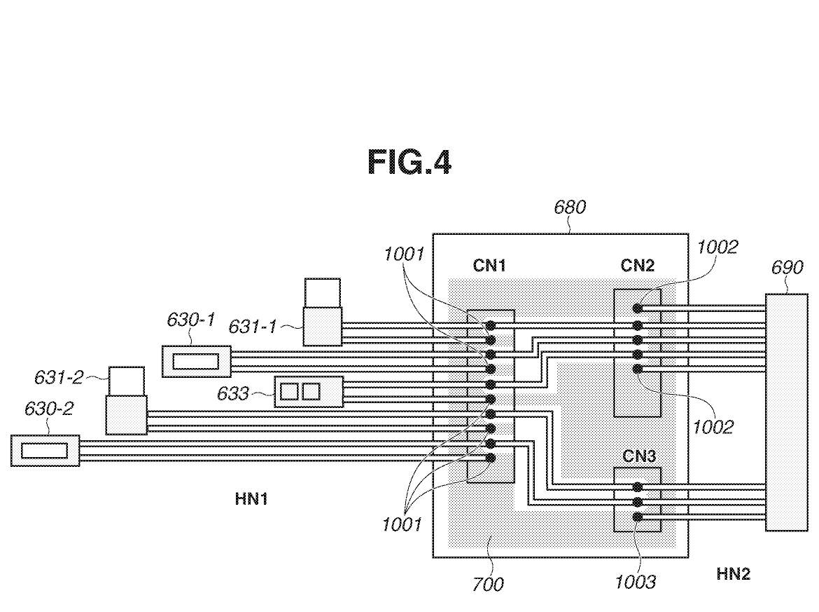

As described above, the fixing device 911 includes the fixing heater 600 and the fixing film 650. The fixing device 911 also includes two heater thermistors 631-1 and 631-2 that detect temperatures at two different points on the fixing heater 600, and two film thermistors 630-1 and 630-2 that detect temperatures at two different points on the fixing film 650. Further, the fixing device 911 includes a sheet sensor 633 (FIG. 4) that detects a sheet passing through the fixing device 911. The heater thermistor 631, the film thermistor 630, and the sheet sensor 633 may be each be referred to as a fixing sensor. As described above, the fixing sensors acquire information about the fixing device 911, such as the temperature and sheet passing status.

The fixing device 911 is provided with the relay board 680 that relays signals from various fixing sensors and ground potential (GND potential). A wire bundle HN1 connects the fixing sensors to the relay board 680. The relay board 680 is connected to the drawer connector 690 by a wire bundle HN2.

The fixing device 911 is connected to the heater control unit 406 of the printer main body 900 via the drawer connector 690. A wire bundle HN3 connects the drawer connector 690 to the heater control unit 406. The drawer connector 690 is also connected to a power supply that includes a pull-up resistor.

A switching unit 404 and the heater control unit 406 are disposed on the periphery of the fixing device 911. The heater control unit 406 controls power supply to the heating element 620 of the fixing heater 600 by controlling an on/off status of the switching unit 404. If the switching unit 404 is on, power is supplied from a power supply 401 to the fixing heater 600.

In accordance with attachment and detachment of the fixing device 911 to and from the printer main body 900, the drawer connector 690 connects and disconnects the wire bundle HN2 in the fixing device 911 and the wire bundle HN3 in the printer main body 900. In other words, by providing the drawer connector 690, electrical connection between the heater control unit 406 and the fixing heater 600 is established if the fixing device 911 is attached to the printer main body 900.

FIG. 4 is a schematic diagram illustrating the relay board 680 according to the present embodiment, as well as the various fixing sensors and the drawer connector 690.

The relay board 680 includes connectors CN1, CN2, and CN3.

The connector CN1 illustrated in FIG. 4 is configured to connect to the various fixing sensors in the fixing device 911. The connectors CN2 and CN3 are connected to the drawer connector 690. According to the present embodiment, the total number of pins of the connectors CN2 and CN3 is less than the number of pins of the connector CN1. Accordingly, the total number of wires in the wire bundle HN2 is less than the total number of wires in the wire bundle HN1.

The relay board 680 has a GND pattern 700. The GND pattern 700 is a wiring pattern formed of a conductor. The GND pattern 700 provides a common electrical connection between GND terminals (GND pins) 1001 of the connector CN1, GND terminals (GND pins) 1002 of the connector CN2, and a GND terminal (a GND pin) 1003 of the connector CN3. The GND pattern 700 forms at least two paths from the GND terminals 1001 of the connector CN1 to the GND terminals 1002 of the connector CN2. Similarly, the GND pattern 700 forms at least two paths from the GND terminals 1001 of the connector CN1 to the GND terminals 1003 of the connector CN3. This configuration can reduce the possibility of disconnection of the GND wiring on the relay board 680. The GND pattern 700 on the relay board 680 is a solid pattern formed over a wide area. Accordingly, the resistance of the GND wiring can be reduced.

A plurality of fixing sensors are each supplied with the GND potential. In other words, the wire bundle HN1 includes a plurality of GND wires (wires that supply the GND potential) respectively corresponding to the plurality of fixing sensors. Further, the wire bundle HN2 includes at least a GND wire that connects the GND terminal of the connector CN2 to the drawer connector 690 and a GND wire that connects the GND terminal of the connector CN3 to the drawer connector 690.

As illustrated in FIG. 4, since the GND pattern 700 is common, the GND wire of the wire bundle HN2 is branched into at least two wires and connected to different pins of the drawer connector 690. Accordingly, while the wire bundle HN1 includes the GND wires (five wires in the present embodiment) corresponding to the number of fixing sensors in the fixing device 911, the number of the GND wires can be reduced in the wire bundle HN2 that connects the relay board 680 and the drawer connector 690. As a result, the apparatus can be miniaturized. Even in a case where a disconnection occurs in a part of the path of the GND wiring from the fixing device 911 to the heater control unit 406, it is possible to appropriately supply the GND potential to the fixing sensors. As a result, the various fixing sensors can maintain their functions.

The drawer connector 690 includes at least two GND terminals. At least one terminal is disposed between the two GND terminals. With this configuration, even if one side of the drawer connector 690 is lifted at the time of inserting the fixing device 911 into the printer main body 900, one of the GND terminals will likely be connected to the heater control unit 406 of the printer main body 900. As a result, the functions of the various fixing sensors are maintained. According to the present embodiment, the GND terminal is assigned to each end of the drawer connector 690, making it easier to maintain the functions of the various fixing sensors.

As described above, the wire bundle HN2 connects the relay board 680 to the drawer connector 690. The wire bundle HN2 includes the GND wire that connects the GND terminal of the connector CN2 of the relay board 680 to the GND terminal of the drawer connector 690, and the GND wire that connects the GND terminal of the connector CN3 of the relay board 680 to the GND terminal of the drawer connector 690. Thus, even if either the connector CN2 or the connector CN3 is disconnected, the other connector maintains the connection of the GND wiring from the relay board 680 to the drawer connector 690.

According to the present embodiment, the two heater thermistors 631 are provided. One heater thermistor 631-1 is connected to the connector CN2. The other heater thermistor 631-2 is connected to the connector CN3. Thus, even if either the connector CN2 or the connector CN3 is disconnected, the heater thermistor 631 can still function properly. The same applies to the two film thermistors 630. As a result, the reliability of temperature monitoring for the fixing device 911 can be improved.

As described above, according to the present embodiment, the GND wiring is shared in the relay board 680 in the fixing device 911 provided with the plurality of fixing sensors. With this configuration, for example, it is possible to reduce the number of signal lines to the drawer connector 690, thereby enabling a reduction in the external size of the fixing device 911. Alternatively, it is possible to improve the reliability of the functions of the various fixing sensors.

According to the embodiments of the present disclosure, it is possible to improve the reliability of sensors in a fixing device.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-054676, filed March 28, 2025, which is hereby incorporated by reference herein in its entirety.

What is claimed is:

1. A fixing device configured to fix a toner image formed on a recording medium, the fixing device comprising:
a fixing heater;
at least one sensor configured to acquire information about the fixing device;
a drawer connector; and
a relay board configured to relay a connection between the at least one sensor and the drawer connector,
wherein the relay board includes:
a first terminal and a second terminal that are connected to the at least one sensor;
a third terminal and a fourth terminal that are connected to the drawer connector; and
a wiring pattern electrically connecting the first terminal, the second terminal, the third terminal, and the fourth terminal to one another.

2. The fixing device according to claim 1, wherein the relay board includes a first connector that includes the first terminal and the second terminal.

3. The fixing device according to claim 2, wherein the relay board includes a second connector that includes the third terminal and a third connector that includes the fourth terminal.

4. The fixing device according to claim 1, wherein ground potential is supplied to the wiring pattern.

5. The fixing device according to claim 1, wherein the drawer connector is connected to a control unit configured to control the fixing device.

6. The fixing device according to claim 1, wherein the at least one sensor includes a thermistor.

7. The fixing device according to claim 1, wherein the at least one sensor is configured to detect a recording medium.

8. The fixing device according to claim 1, wherein the drawer connector includes:
a fifth terminal that is connected to the third terminal;
a sixth terminal that is connected to the fourth terminal; and
a seventh terminal that is disposed between the fifth terminal and the sixth terminal.

9. The fixing device according to claim 1, wherein the drawer connector is connected to a power supply having a pull-up resistor.

10. An image forming apparatus comprising:
an image forming unit configured to form a toner image on a recording medium; and
the fixing device according to claim 1.
